(19) United States
(12) Patent Application Publication
(10) Pub. No.: US 2010/0095318 A1
(43) Pub. Date: Apr. 15, 2010

(54) System and Method for Monitoring Audience Response

(76) Inventor: William Wagner, Escondido, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/250,961

(22) Filed: Oct. 14, 2008

(51) Int. Cl. H04H 60/32

(52) U.S. Cl. 725/14

(57) ABSTRACT

A system and method are provided for monitoring audience response to a display is disclosed. The method includes measuring audience response to the display by obtaining an electronic video stream at the display. Another operation tags the video stream based on changes in audience response measured at the display, and converts the tagged video stream into quantized audience response data at the display. The quantized audience response data may be processed into audience response analytics through statistical analysis at the display.

### BACKGROUND

Electronic billboards, light box posters, electronic signs, and video window displays are rapidly growing areas of marketing investment. However, one challenge facing the signage industry, and point of sale marketing in general, is the lack of the ability to measure a clear return on the investment required to post and maintain the signage. Advertisers may maximize their advertising dollars by analyzing information on which advertisements are most effective in influencing customers to make a purchase. Also given information on which placements of advertisements are most effective, owners of signage structures and equipment can maximize return on their investment dollars selling prime advertisement space for higher prices.

Commercial systems for monitoring advertising or display effectiveness often rely on surveys, active monitoring and recording by a human located near the display or video recording for later review and analysis. Each of these methods involves human participation and creates a time lag between the viewing event and the availability of any data about the audience.

Digital signage networks often comprise an array of displays installed throughout a large area. Each of these displays within the network represents a significant financial and infrastructure investment on the part of the venue. Presently it can be difficult to monitor and evaluate the effectiveness of the network to increase sales or otherwise to accrue benefit to the investor.

### BRIEF DESCRIPTION OF THE DRAWINGS

FIG. 1 depicts a method for monitoring audience response to a display in accordance with an embodiment;

FIG. 2 depicts an audience response monitoring device in accordance with an embodiment;

FIG. 3 depicts possible placements for audience response monitoring devices in and near a display in accordance with an embodiment;

FIG. 4 depicts an audience response monitoring system communicating over a network in accordance with an embodiment; and

FIG. 5 depicts a method for combining response analytics from a plurality of displays into composite analytics at a computing server and displaying results on a web page in accordance with an embodiment.

### DETAILED DESCRIPTION OF EXAMPLE EMBODIMENTS

In describing embodiments of the present invention, the following terminology will be used.

The singular forms “a,” “an,” and “the” include plural referents unless the context clearly dictates otherwise. Thus, for example, reference to “a device” includes reference to one or more of such devices.

Reference will now be made to the exemplary embodiments illustrated, and specific language will be used herein to describe the same. It will nevertheless be understood that no limitation of the scope of the invention is thereby intended.

Recording continuous sign surveillance video from multiple cameras and signs is a bandwidth transmission and memory cost issue. Where large numbers of cameras are run twenty four hours a day, seven days a week in public forums such as in airports and shopping centers, recording and transmitting video can present difficult technical problems. Transmission and memory issues may be solved by generating analytics at the camera and discarding the preliminary data and video feed.

In addition, it is impractical to employ workstations and personal computers at retail displays or wall mounted signage for processing statistical information due to space and cost constraints. Rather, an integrated solution having a small form factor may be deployed in large numbers at multiple retail locations or advertising locations over a network.

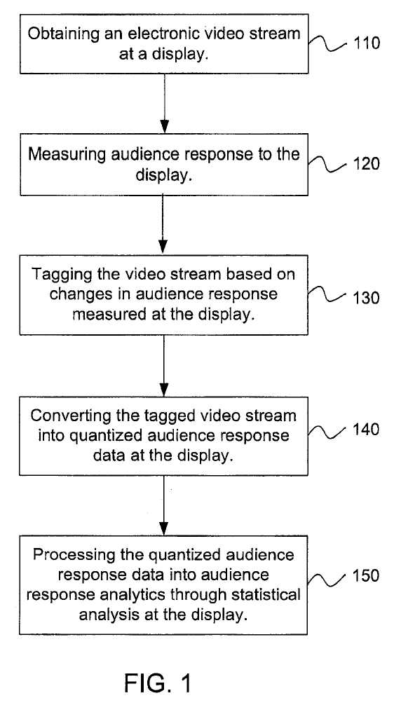

FIG. 1 depicts a method for monitoring audience response to a display in accordance with an embodiment. A display may include static signage, a dynamic electronic display or both. For example, a display may include video screens, electronic signs, printed billboards, light box posters, and retail store window displays. Other examples of displays can be any type of retail display, projected advertisements, live streaming video, and live demonstrations.

An electronic video stream may be obtained by a video camera at a display, as in operation 110. Audience response to the display may be measured, as in operation 120. The video stream can be tagged based on changes in audience response measured at the display, as in operation 130. Measuring changes in the audience, response may include counting the number of people in the audience at a given time, measuring a change in the audience size, counting the number of gazes to the display from each person in the audience, and determining the duration of each gaze to the display from each person in the audience. A change in audience response measured at the display for tagging the video stream may also include a physical interaction of the display such as at a touch screen or a card reader.

The tagged video stream can be converted into quantized audience response data at the display as in operation 140. The quantized audience response data is further processed into audience response analytics through statistical analysis at the display as in operation 150. These response analytics can include statistical analysis and data mining, but may also be based on audience modeling involving extensive computation. The analytics can also comprise software that analyzes data about an audience's response to advertising and presents the analyzed data so that better and quicker business decisions can be made. Generated analytics may further include classifying audience demographics and determining emotional reaction to the display.

Furthermore, the analytics may be sent across a network to an external device for further processing.

The steps of tagging, converting, and processing may be performed on a frame by frame basis or over defined time segments on the electronic video stream at the display. Audience response analytics may be stored at the display and retrieved by remote systems over a network. The quantized audience response data and the tagged media stream or raw video stream may be discarded (i.e., deleted) and therefore does not consume transmission bandwidth nor memory space when transmitted over a network to an external device. Distributed processing enables very large arrays of audience response monitoring devices to capture and process audience responses on a twenty-four hour, seven day a week basis.

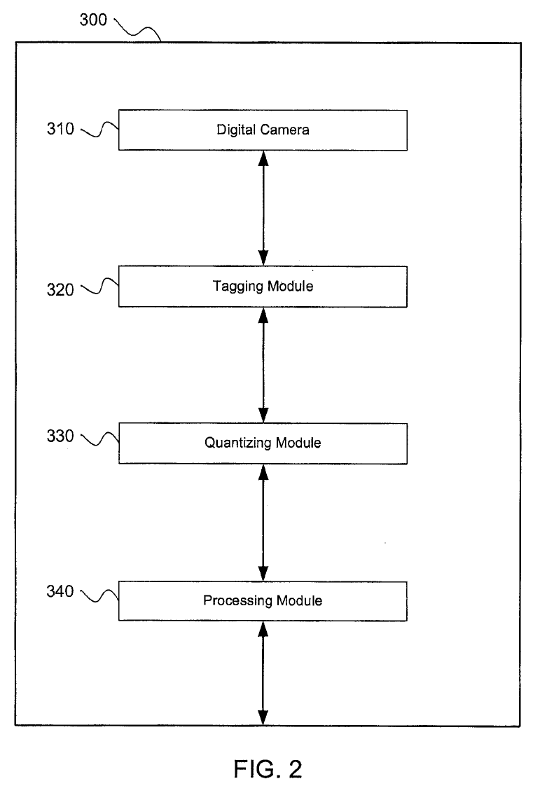

FIG. 2 is an audience response monitoring (ARM) device 300 in accordance with an embodiment. A digital camera 310 may be configured to convert audience response to a display into an electronic video and/or audio stream. A tagging module 320 at the display in communication with the digital camera can tag the video stream based on changes in audience response measured at the display.

A quantizing module 330 may convert the tagged media stream into quantized audience response data at the display. A processing module 340 generates audience response analytics at the display from the quantized data. Data, control signals and power may be distributed by a bus or network connection between all the modules in the audience response monitoring device. The processing module may also be used for communication between the device and external devices. Additionally a database may be in communication with the processing module configured to store the audience response analytics at the display. A communications module may be coupled to the processing module and coupled to the database and be configured to deliver the audience response analytics to an external device.

The modules discussed herein, such as the tagging module, quantizing module and processing module, may be embodied in hardware or software. For example, all of the modules may be contained on a single custom hardware chip or field programmable gate array (FPGA). In contrast, each module might be contained within its own hardware chip. Alternatively, these modules may be embodied in software that is executed by a general purpose processing system.

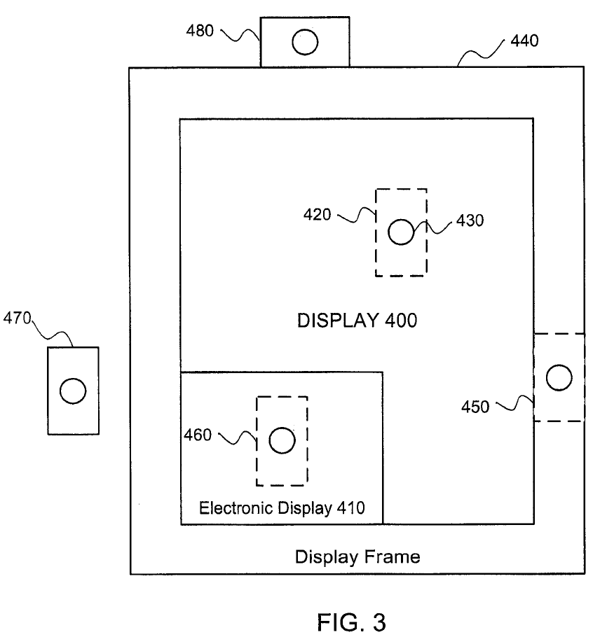

FIG. 3 depicts placements for audience response measuring devices in or at a display 400 including an electronic display component 410. Placements depicted represent classes of possible placements and therefore should not be construed as limiting placements to only the depicted areas. A centralized placement 420 represents devices embedded in a display where only the camera lens 430 is visible to the audience. Accordingly, the body of the video capture device which may not be adjacent or near the display face, is shown in broken lines.

Embedded placement in the frame or perimeter of a display 440 is depicted by placement 450. Embedded placement in an electronic display screen 460 represent placements of the device where only the camera lens or a portion thereof may be adjacent the display facade. Placements of a camera standing alone adjacent a display 470, and standing alone bordering the display 480 depict the entire audience response measuring (ARM) device including camera lens in accordance with an embodiment. ARM devices may also be placed in or on existing structures near displays such as posts and walls.

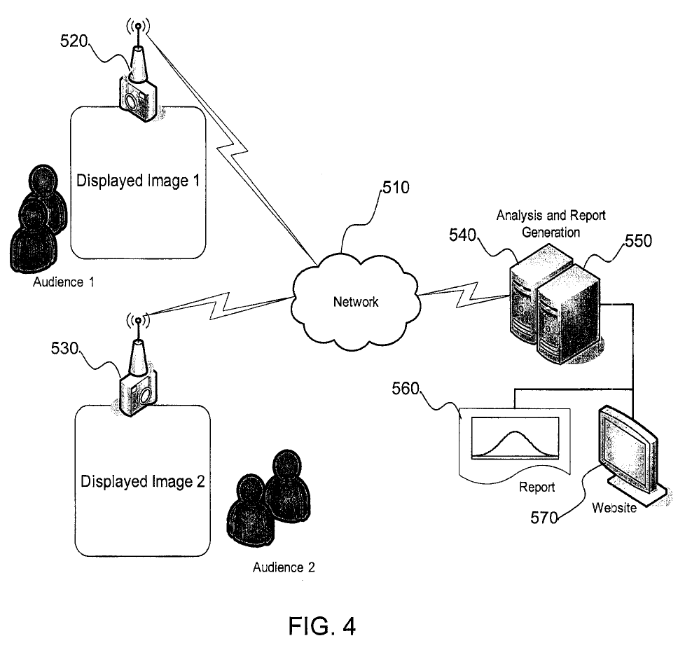

FIG. 4 depicts an audience response monitoring system communicating over a wireless network 510 in accordance with an embodiment. Multiple ARM devices 520 and 530 provide for measuring audience response at respective displays. The ARM devices are configured to generate analytics from the audience response and to transmit the analytical information over the network through wireless connections and protocol. Alternate embodiments (not depicted) may include wired networks, wireless telephone networks, RFID (radio frequency identification) readers, and other telemetry devices and respective protocol. Multiple computing servers 540 and 550 in communication with the network can have a statistical processing module generating further analytics and reports 560 from the distributed device analytics for display, such as on a website 570.

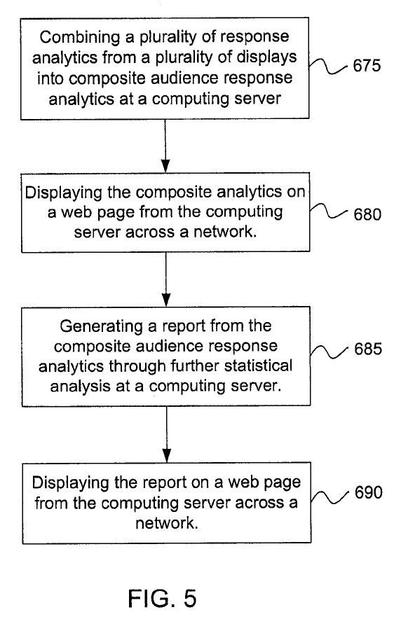

FIG. 5 depicts a method for combining response analytics from several displays into composite analytics as in block 675. The combination operation may include aggregating, concatenating, interweaving and grouping operations. The composite analytics may be displayed from a server across a network to a web page as in block 680. In an alternate embodiment the composite analytics may be used to generate management reports as in block 685. Management reports can also be displayed on a web page from the computing server across the network as in block 690.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A method for monitoring audience response to a display, comprising:
obtaining an electronic video stream at a display;
measuring audience response to the display;
tagging the video stream based on changes in audience response measured at the display;
converting the tagged video stream into quantized audience response data at the display; and
processing the quantized audience response data into audience response analytics through statistical analysis at the display.

2. A method as in claim 1, further comprising storing the audience response analytics at the display.

3. A method as in claim 1, further comprising transmitting the analytics across a network to an external device.

4. A method as in claim 1, wherein the steps of tagging, converting, and processing are performed on a frame by frame basis on the electronic video stream at the display.

5. A method as in claim 1, further comprising the steps of:
discarding the quantized audience response data; and
discarding the tagged media stream.

6. A method as in claim 1, wherein a change in audience response measured at the display for tagging the video stream includes at least one gaze to or away from the display from at least one person in the audience.

7. A method as in claim 1, wherein a change in audience response measured at the display for tagging the video stream is physical interaction with the display.

8. A method as in claim 1, wherein the step of processing the quantized audience response data into audience response analytics further comprises:
counting the number people in the audience at a given time;
counting the number of gazes to the display from each person in the audience; and
determining the duration of each gaze to the display from each person in the audience.

9. A method as in claim 1, wherein the step of processing the quantized audience response data into audience response analytics further comprises the step of classifying audience demographics.

10. A method as in claim 1, wherein the step of processing the quantized audience response data into audience response analytics further comprises the step of determining emotional reaction to the display.

11. A method as in claim 1, further comprising the steps of:
combining a plurality of response analytics from a plurality of displays into composite audience response analytics at a computing server; and
displaying the composite analytics from the computing server across a network.

12. A method as in claim 9, further comprising the steps of;
generating a report from the composite audience response analytics through further statistical analysis at a computing server; and
displaying the report from the computing server across a network.

13. A method as in claim 1, wherein the steps of tagging, converting, and processing are performed on a determined time segment basis for the electronic video stream at the display.

14. An audience response monitoring device comprising:
a digital camera configured to convert audience response to a display into an electronic video stream;
a tagging module at the display configured to tag the video stream based on changes in audience response measured at the display;
a quantizing module configured to convert the tagged media stream into quantized audience response data at the display; and
a processing module configured to generate audience response analytics at the display from the quantized data.

15. A device as in claim 14, further comprising a database in communication with the processing module, the database being configured to store the audience response analytics at the display.

16. A device as in claim 14, further comprising a communications module coupled to the processing module and coupled to the database and being configured to deliver the audience response analytics to an external device.

17. A device as in claim 14, wherein the digital camera placement is a placement selected from the group consisting of embedded placement in a still image display, embedded placement in the frame of a display, placement standing alone adjacent a display, placement standing alone bordering a display and embedded placement in an electronic display screen.

18. A device as in claim 14, wherein the video stream and tagged media stream are discarded.

19. An audience response monitoring system communicating over a network comprising:
a plurality of audience response monitoring devices each configured to measure audience response at a display and to generate analytical information at the display from the audience response;
a computing server in communication with the plurality of audience response monitors over the network, the computing server having a statistical processing module configured to generate reports and analytics from the quantized information generated at the audience response monitoring devices.

20. A system as in claim 19, further comprising a web server embedded in the computing server and configured to display analytics and reports on a web page across the network.

21. A system as in claim 19 wherein the video stream is discarded.
